(19) United States
(12) Patent Application Publication
(10) Pub. No.: US 2008/0067196 A1
(43) Pub. Date: Mar. 20, 2008

(54) Pump For Fluid Product Dispenser Having A Body Comprising An Assembling And Sealing Flange Ring

(76) Inventor: Jean-Luc Octau, Intraville (FR)

Correspondence Address: ST. ONGE STEWARD JOHNSTON & REENS, LLC, 986 BEDFORD STREET, STAMFORD, CT, 06905-5619, US

(21) Appl. No.: 11/875,540

(22) Filed: Oct. 19, 2007

Related U.S. Application Data
(63) Continuation of application No. PCT/FR2006/050227, filed on Mar. 14, 2006.

(30) Foreign Application Priority Data
Apr. 21, 2005 (FR) 0504010

(51) Int. Cl. B67D 5/40

(52) U.S. Cl. 222/321.7

(57) ABSTRACT

The invention concerns a pump for fluid product dispenser comprising a bottle designed to contain the product, the bottle having an upper opening delimited by a neck wherein the pump is inserted, the pump comprising a generally cylindrical pump shell delimiting a compression chamber, the pump shell extending radially through an annular assembling flange ring made in a single-unit with the upper part of the shell, the flange ring having a lower surface designed to be urged into deforming sealed contact on a support zone provided on the upper part of the neck. The invention also concerns a dispenser comprising such a pump.

### CROSS-REFERENCE TO RELATED APPLICATIONS

The present application is a continuation of pending International patent application PCT/FR2006/050227 filed on Mar. 14, 2006 which designates the United States and claims priority from French patent application 0504010 filed Apr. 21, 2005, the content of which is incorporated herein by reference.

### FIELD OF THE INVENTION

The present invention relates to a pump for a fluid product dispenser as well as a fluid product dispenser including such a pump.

### BACKGROUND OF THE INVENTION

Fluid product dispensers are known, as described in U.S. Pat. No. 5,950,880 which include a bottle intended to contain the product and have an upper opening defined by a neck in which a pump is introduced. The pump includes a generally cylindrical pump casing defining a compression chamber and including a piston—valve mechanism.

To make the bottle tight as far as the fluid product is concerned, a radial tightness is obtained through a sealing gasket placed on a transversal edge of the neck.

Additionally, there is an embodiment in which the pump casing is mounted tight into the neck to obtain an axial tightness which can be combined with the radial tightness.

Now, such sealing methods make the manufacturing of the pump more complex and are a problem as regards the adaptability of the pump to the various types of bottles.

As a matter of fact, using an added sealing gasket increases the number of operations for mounting the dispenser and requires delicate gasket positioning and fastening procedures.

Additionally, drastic tolerance constraints are applied to the pump manufacturing method so that the dimensions of the body, and more particularly its diameter, are adapted to those of the neck so as to secure a tight sealing contact. Constraints are more particularly imposed when the bottle is made of a rigid material, the formability of which is very low. The pump casing can then lose its shape in an uncontrolled way during its introduction into the neck, which can lead to a malfunctioning of the mechanism.

Additionally, considering the variety of dimensions and shapes of a bottle and the various dimensions of necks it becomes necessary to make standard pumps which can be adapted to various necks without the quality of the distribution and the sealing of the dispenser being compromised. This adaptability cannot be obtained by pumps the dimensions of which are adjusted to those of a special neck.

### SUMMARY OF THE INVENTION

The present invention aims at remedying such problems by providing a pump, the casing of which includes a flange which combines the embodiments for the mounting of the pump on the neck of a bottle and the sealing of the bottle.

Therefore, and according to a first aspect, the invention provides a pump for a fluid product dispenser including a bottle intended to contain such product, such bottle having an upper opening defined by a neck in which the pump is introduced, said pump comprising a generally cylindrical pump casing defining the compression chamber, the pump casing radially extending into another mounting flange made integral with the upper part of the said casing, such flange having a lower face intended to come into tight contact and get deformed on a support area arranged on the upper part of the neck.

Thus, the mounting of the pump onto a dispenser and the sealing obtained using a radial flange allow to do without the use of an added gasket and the constraints concerning the dimensions of the pump casing, which simplifies the pump manufacturing method and improves its adaptability to various types of bottles.

The support area may include a transversal support surface arranged on an upper edge of the neck.

According to one embodiment the mounting flange has a deformable portion with a lesser thickness.

It is thus possible to give the flange some flexibility so as to be able to adapt the pump and block it satisfactorily on the neck of a bottle. This embodiment also makes it possible to provide, on the same flange, portions enhancing the sealing function or the blocking function or portions combining both functions.

The deformable portion with a lesser thickness includes a groove arranged on the lower face of the mounting flange.

More particularly the ring may be flared so as to secure the positioning and blocking of the pump casing, by cooperation with a protruding ring carried by the support area arranged on the neck.

According to a possibly complementary alternative, the deformable portion with a lesser thickness includes a cavity arranged on the upper face of the mounting flange.

In some embodiments, the deformable portion with a lesser thickness is a middle portion of the mounting flange forming a hinge, so that an outer portion of said flange located between the deformable portion with a lesser thickness and the free end forms a flexible wing.

The support area may also include a side blocking surface arranged on an outer side edge of the neck and a angular coupling surface arranged on an angular edge of the neck which connects the upper edge and the side edge, the flexible wing having a back which axially extends to the bottom part, said back being intended to come into a tight contact with the side blocking surface by covering the coupling angular surface.

The thickness of the flexible wing may decrease in the vicinity of the free end.

According to a second aspect, the invention relates to a fluid product dispenser including a pump according to the first aspect, the dispenser including a bottle intended to contain said product, said bottle having an upper opening defined by a neck in which the pump is introduced, the dispenser further having a mounting socket crimped on the neck and on the upper face of the mounting flange, so that the lower face of the mounting flange comes into a deforming tight contact with a support area arranged on the upper part of the neck.

According to a particular embodiment, the mounting flange radially extends inwards, so as to protrude on the neck opening.

The outer diameter of the pump casing can thus be lower than the inner diameter of the bottom neck. A pump may thus be adapted to bottles having different dimensions and shapes without any risk of damage.

### BRIEF DESCRIPTION OF THE DRAWINGS

Other objects and advantages of the invention will become apparent when reading the following description which is made with reference to the appended drawings wherein:

FIG. 1 is a partial longitudinal cross section of a dispenser including a pump, according to a first embodiment, introduced into the opening of a bottleneck, the pump comprising a radial flange, the lower surface of which is in deforming tight contact with the neck, the flange comprising a middle blocking groove and a flexible outer wing;

FIG. 2 is a partial longitudinal cross section of the pump according to an alternative of the embodiment of FIG. 1 being mounted onto the neck, the flange having a cavity arranged on the upper face, the flexible wing having a back and being adapted to allow the blocking and coupling of the flange onto the neck;

FIG. 3 is an analogous illustration to that of FIG. 1 of a dispenser comprising the pump of FIG. 2 secured onto the bottle neck after the mounting of a socket.

### DETAILED DESCRIPTION OF THE INVENTION

A liquid product dispenser is described with reference to these figures. In particular examples, the liquid product is a cosmetic or pharmaceutical product or a perfume.

The dispenser is composed of a bottle 1 including a bottom wall and a cylindrical wall having an axis D, which extends perpendicularly from the edge of the bottom wall so as to define an accommodation intended to contain the product. The bottle 1 may further include a covering wall which extends perpendicularly to the cylindrical wall from the edge opposite the bottom wall. The covering wall has an opening 2 through which the product can be introduced into the bottle 1 or be delivered.

In the following description, the words “axial”, “longitudinal” or “side” and “radial” or “transversal” respectively refer to planes parallel and perpendicular to axis D. Additionally, the words “lower” and “upper” must be understood with respect to the direction of the bottle 1 resting on the bottom wall. The words “lower” and “upper” thus refer to transversal planes located close to and away from the bottom wall, respectively. Finally, the words “inner” and “outer” refer to longitudinal planes located close to and away from the accommodation, respectively.

The upper opening 2 can be defined by a neck 3. The neck 3 includes an axial cylindrical part 4 which extends from the covering wall and a radial edging of the periphery and protruding from the free end of the axial part 4. The radial edging 5 has an upper transversal edge 18, an outer side edge 23, an angular edge 19 which connects the upper edge 18 and the side edge 23 and a lower transversal shoulder 24.

To deliver the fluid product contained in the bottle 1, the dispenser is provided with a spraying device. The device includes side manual operation head 6, made integral with a pump introduced in the neck 3, by pressing on it, for instance.

The pump includes a generally cylindrical pump casing 7 having two open ends. The pump casing 7 defines a compression chamber in its lower part. Additionally, the pump casing 7 has a mechanism in which a piston element 8, which can slide tightly in the pump casing 7, cooperates with an inlet valve to fill the compression chamber with the product or to empty it.

The piston element 8 includes an axial channel 13 allowing a fluid communication between the compression chamber and a spraying hole 14 provided on the nozzle 15 mounted on the operation head 6.

A tube has an upper end opening in the compression chamber and a lower end located close to the bottom wall of the bottle 1.

The upper end of the pump casing 7 is closed by an extensor 9 made integral with the body 7 and having an axial bore 10 for guiding the piston 8 when the latter slides. In the figures pins 11 are formed on the outer face of the extensor 9 and are inserted into notches 12 arranged on the inner face of the pump casing 7 to allow the extensor 9 to be press fitted into the pump casing 7.

Additionally, the pump casing 7 radially extends into an annular mounting flange 16 made on the upper part of the body 7. In the figures, the mounting flange 16 is made integral with the upper free end of the body 7.

In some other embodiments, the annular mounting flange 16 can be axially shifted with respect to the upper free end or can be constituted of an added annular part rigidly associated with the pump casing 7. In the later case, the mounting flange 16 can be made in a material different from that of the pump casing 7 and adapted to the hereunder described functions of the flange 16.

The pump is introduced into the neck 3 until the lower face of the flange 16 comes into deforming tight contact on a support area arranged on the upper part of the neck 3.

The support area may include a transversal support surface arranged on the upper edge 18.

The transversal support surface may compose the whole or a part of the upper transversal edge 18. In the figures, the radial dimension of the mounting flange 16 is provided so that its free end is in the vicinity of the angular edge 29.

To secure the holding in position of the pump and the deforming tight contact of the lower face of the mounting flange 16 on the transversal support surface the dispenser further comprises a mounting socket 19 crimped on to the neck 3 and onto the upper surface of the mounting flange 16.

Additionally, the extensor 9 also comprises a radial protrusion 20, the lower face of which rests on the upper face of a lower portion of the mounting flange 16. The socket 19 is then deformed so as to provide a support on the upper face of the radial protrusion 20 and a support on the upper phase of the middle and outer portions of the mounting flange 16. The socket 19 is then folded along the outer side edge 23 of the radial edging 5 and formed to make a coupling onto the shoulder 24.

In the particular embodiment shown, the mounting flange 16 radially extends inwards so as to protrude on the opening of the neck 3.

The outer diameter of the pump casing 7 can thus be lower than the inner diameter of the neck 3, so that the outer side face of the pump casing 7 is positioned away from the inner face of the neck 3. A so called “standard” pump is thus obtained, which can be sealingly adapted onto necks having various dimensions and shapes, without imparting constraints to the pump casing 7 proper.

In other embodiments however the dimensions of the pump casing 7 could be adjusted to that of the neck 3.

According to the embodiment shown, the mounting flange 16 has a deformable portion with a lesser thickness 21.

More particularly, the deformable portion with a lesser thickness 21 is in the middle. The portion with a lesser thickness 21 can thus be shaped as a hinge so that the outer portion of the flange located between the deformable portion with a lesser thickness 21 and the free end forms a flexible wing 22.

The thickness of the flexible wing 22 can decrease in the vicinity of the free end to give the upper face of the flexible wing 22 a generally rounded shape. This embodiment facilitates the deformation of the socket 19 and forms a transition curve between the middle and outer portions of the flange 16 on the one hand and the outer side edge 23 and radial edging 5 on the other hand. The contact of the mounting flange 16 on the transversal surface supporting the neck 3 is then uniformly distributed on a larger surface which enhances the assembling and the sealing of the bottle 1.

In the example shown, the deformable portion with a lesser thickness 21 includes a rib 25 arranged on the lower face of the mounting flange 16.

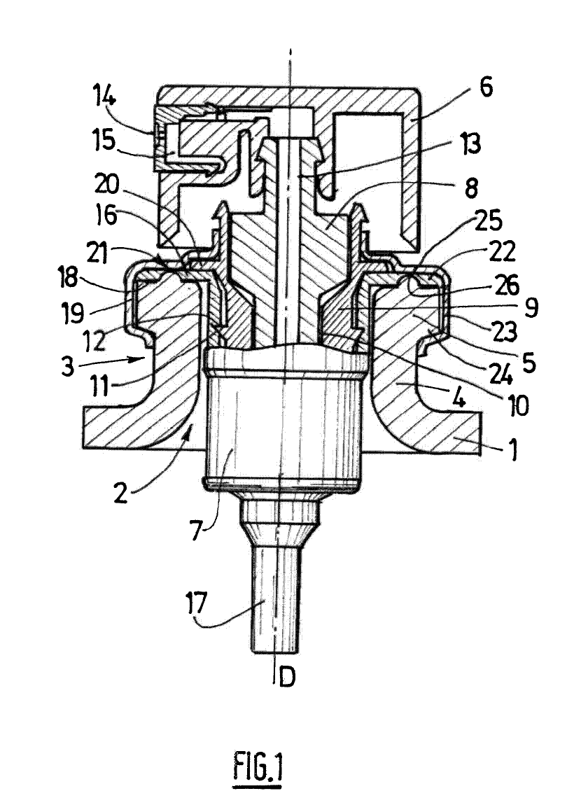

In FIG. 1, the rib 25 is flared so as to have two diverging sloping walls towards the lower transversal face and secure the positioning and the blocking of a pump casing 7, through a cooperation with a protruding ring 26 carried by the support area arranged round the neck 3. The ring 26 can be carried by the transversal support surface. Additionally, the rib 25 placed on the ring 26 in a sealing contact by means of the socket 19 also makes it possible to add some tightness.

The sloping walls allow the outer face of the, for example, truncated ring to slide so as to facilitate the positioning and the blocking. Additionally the capacity of the flexible ring 22 to deform makes it possible not to take into account the accurate relative positioning of the rib 25 with respect to the ring 26 and to obtain enhanced positioning and blocking while securing added sealing. This flexibility also gives a better adaptability of the pump to various necks or necks having various dimensions.

The thus obtained flange 16 makes it possible to separate at least partially the sealing, blocking, and positioning functions of the flange. More particularly, the sealing is mainly obtained by the lower and outer portions because the protrusion 20 of the extensor 9 and the mounting socket 19 are supported. The blocking and the positioning are mainly obtained by the middle portion with a lesser thickness 21.

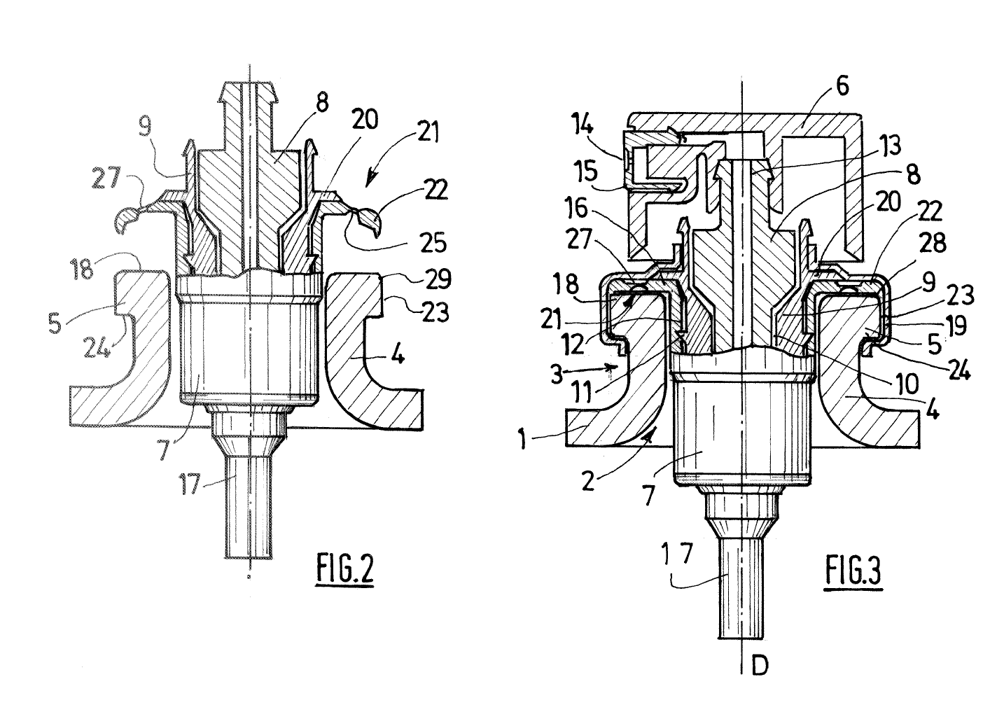

As an alternative which may be a complement, such as shown in FIGS. 2 and 3, the deformable portion with a lesser thickness 21 also includes a cavity 27 arranged on the upper face of the mounting flange 16.

In FIG. 3, it is provided that the support area also comprises a side blocking surface arranged on the whole or part of the outer edging 23 and a coupling surface arranged on the whole or part of the angular edge 29.

The flexible wing then has a back 28 which axially extends downwards. The back 28 comes into tight contact with the side blocking surface by covering the coupling angular surface.

In this alternative, the blocking can be obtained by the middle portion of the flange 16 cooperating with a ring 26 and the rib 25 and/or the outer portion of the flange 15 and the back 28. The positioning of the pump casing 7 is simplified thanks to the flexibility of the wing 22. This flexibility also favors the coupling of the pump casing 7 on necks having various dimensions. The sealing is mainly obtained radially by the inner and outer portions of the flange 16 and axially by the back 28.

It can also be provided that the flexible wing 22 is sloping downwards with respect to the inner portion of the flange 16. Such embodiment is shown in FIG. 2 and allows the flange 16 to better follow the support area of the upper part of the neck 3 and thus to enhance the blocking and the coupling of the pump casing 7.

1. A pump for a fluid product dispenser comprising a bottle intended to contain said product, said bottle having an upper opening defined by a neck wherein the pump is introduced, said pump comprising a generally cylindrical pump casing defining a compression chamber and radially extending into an annular mounting flange made integral with the upper part of said casing and having a lower face intended to come into a sealing contact with the support area arranged on the upper part of the neck, characterized in that the mounting flange has a deformable portion of a lesser thickness.

2. A pump according to claim 1, characterized in that the support area includes a transversal support surface arranged on an upper edge of the neck.

3. A pump according to claim 1, characterized in that the deformable portion with a lesser thickness includes a ring arranged on the lower face of the mounting flange.

4. A pump according to claim 3, characterized in that the rib is flared to secure the positioning and blocking of the pump casing, by means of the cooperation with a protruding ring carried by the support area arranged on the neck.

5. A pump according to claim 1, characterized in that the deformable portion with a lesser thickness comprises a cavity arranged on the upper face of the mounting flange.

6. A pump according to claim 1, characterized in that the deformable portion with a lesser thickness is the middle portion of the mounting flange forming a hinge, so that an outer portion of said flange located between the deformable portion with a lesser thickness and a free end forms a flexible wing.

7. A pump according to claim 6, characterized in that the support area also includes a side blocking surface arranged on an outer side edge of the neck and a plane angular surface arranged on the angular edge of the neck which connects the upper edge and the side edge, the flexible wing having a back which axially extends downwards, said back being intended to come into tight contact with the side blocking surface by covering the coupling angular surface.

8. A pump according to claim 6, characterized in that the thickness of the flexible wing decreases in the vicinity of the free end.

9. A fluid product dispenser including a pump according to claim 1, the dispenser comprising a bottle intended to contain said product, said bottle having an upper opening defined by a neck wherein the pump is introduced, the dispenser further comprising a mounting socket crimped on the neck and the upper face of the mounting flange so that the lower face of the mounting flange comes into a deforming sealing contact on the support area arranged on the upper part of the neck.

10. A dispenser according to claim 9, characterized in that the mounting flange radially extends inwards so as to protrude on the neck opening.
